(19) United States
(12) Patent Application Publication
(10) Pub. No.: US 2014/0240249 A1
(43) Pub. Date: Aug. 28, 2014

(54) SYSTEM AND METHOD OF ANALYZING INPUT ON TOUCH PANEL

(71) Applicant: Acer Incorporated, New Taipei City (TW)

(72) Inventors: Meng-Shih Tsai, New Taipei City (TW); Chueh-Pin Ko, New Taipei City (TW); Ching-Piao Kuan, New Taipei City (TW)

(73) Assignee: Acer Incorporatedtw, New Taipei City (TW)

(21) Appl. No.: 14/159,146

(22) Filed: Jan. 20, 2014

(30) Foreign Application Priority Data
Feb. 27, 2013 (TW) 102106843

(51) Int. Cl. G06F 3/042

(52) U.S. Cl. CPC G06F 3/0425
USPC 345/173

(57) ABSTRACT

The system and method of analyzing input on touch panel are provided. The system includes an electrical device, including a touch panel, wherein plurality of patterns on the touch panel are generated by a manufacturing process; and an input device, including a photograph unit and a processing unit and configured to input a message to the electrical device, wherein when the message is inputted to the electrical device, the input device photographs one or more of the patterns by the photograph unit for generating an image data, analyzes a location information included in the image data by the first processing unit for generating a coordinate information, and transmits the coordinate information to the electrical device through a wireless transmission.

### CROSS REFERENCE TO RELATED APPLICATIONS

This Application claims priority of Taiwan Patent Application No. 102106843, filed on Feb. 27, 2013, the entirety of which is incorporated by reference herein.

### BACKGROUND OF THE INVENTION

1. Field of the Invention

The invention generally relates to analyzing technology of the touch panel, and more particularly, to photograph the patterns generated by a panel-manufacturing process by an input device for providing the information inputted to the touch panel of the electrical device by user.

2. Description of the Related Art

Recently, with the rapid development of communication technology, various portable devices and electrical devices, such as mobile phones, smartphones, personal digital assistants (PDAs), tablet PCs have become more and more technically advanced and multifunctional. Due to the increased convenience of these devices, they have become necessities of life.

In addition, thanks to advances in touch panel manufacturing technology, the user employs the touch panel to operate the electrical device and input data rather than using a traditional keyboard or a mouse. The users can input data more conveniently and directly by using the touch technology. In the touch technology, the user can use a finger or touch pen to input data. Currently, there are many types of touch pens. The two most popular types are the capacitive type and the inductive type.

In addition, for different structures of the touch panel, when the optical reflection of materials of the touch panel is not matched and visible, the tester can see the visible Indium Tin Oxide (ITO) or metals. Generally, the visible Indium Tin Oxide (ITO) or metals are viewed as an issue of the manufacturing process. However, the visible Indium Tin Oxide (ITO) or metals may be able to become a good application. Therefore, how to connect the touch pen technology with the visible Indium Tin Oxide (ITO) or metals generated in the manufacturing process is a worthy subject for discussion.

### BRIEF SUMMARY OF THE INVENTION

Apparatus and methods for acceleration-connection establishment in a mobile communication system are provided to overcome the above-mentioned problems.

An embodiment of the invention provides a system of analyzing an input touch panel, comprising: an electrical device, comprising a touch panel, wherein a plurality of patterns are generated on the touch panel by a manufacturing process; and an input device, comprising a photograph unit and a first processing unit and configured to input a message to the electrical device, wherein when the message is inputted to the electrical device, the input device photographs one or more of the patterns by the photograph unit for generating image data, analyzes location information comprised in the image data by the first processing unit for generating coordinate information, and transmits the coordinate information to the electrical device through a wireless transmission.

An embodiment of the invention provides a method of analyzing the input touch panel for an electrical device which comprises a touch panel, wherein a plurality of patterns are generated on the touch panel by a manufacturing process, comprising: inputting a message to the electrical device by an input device, wherein the input device comprises a photograph unit and a first processing unit; photographing one or more of the patterns by the photograph unit for generating image data when the message is inputted to the electrical device; analyzing location information comprised in the image data by the first processing unit for generating coordinate information, and transmitting the coordinate information to the electrical device through a wireless transmission.

### BRIEF DESCRIPTION OF THE DRAWINGS

The invention will become more fully understood by referring to the following detailed description with reference to the accompanying drawings, wherein:

FIG. 1 is a block diagram of a system 100 for analyzing input on the touch panel according to an embodiment of the invention;

FIG. 2 is a block diagram of the electrical device 200 according to an embodiment of the invention;

FIG. 3 is a block diagram of the input device 300 according to an embodiment of the invention;

FIG. 4 is a flow chart illustrating the method for analyzing input on touch panel according to an embodiment of the invention;

FIG. 5 is a flow chart illustrating the method for analyzing input on touch panel according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

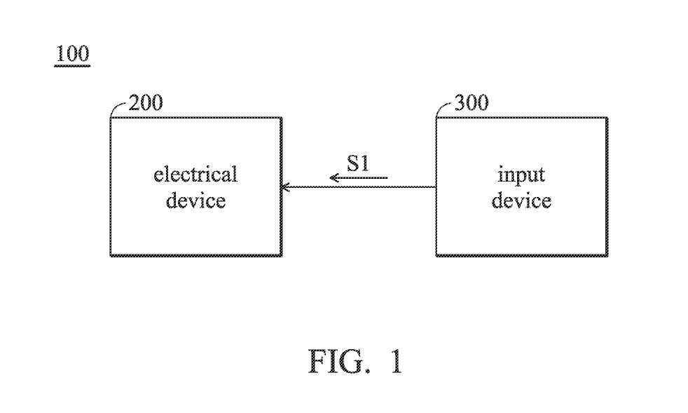

FIG. 1 is a block diagram of a system 100 for analyzing input on touch panel according to an embodiment of the invention. The system 100 comprises an electrical device 200 and an input device 300, wherein the electrical device 200 may be a personal digital assistant (PDA), a smartphone, a notebook, a Tablet PC, a Global Positioning System (GPS) or others. The input device 300 may be a touch pen or a touch ring.

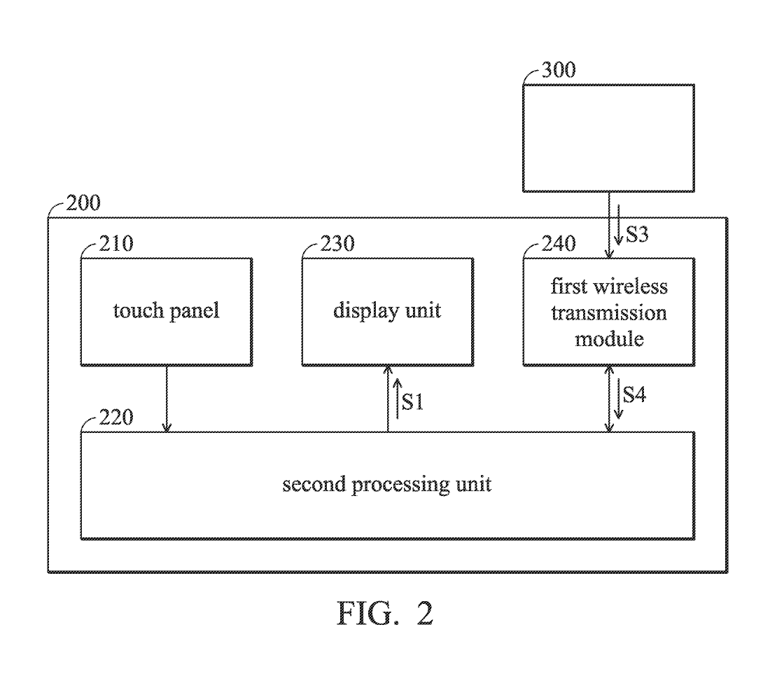

FIG. 2 is a block diagram of the electrical device 200 according to an embodiment of the invention. In one embodiment, the electrical device 200 comprises a touch panel 210, a second processing unit 220 (the “second” processing unit illustrated in the specification is to be consistent with the disclosure of claims), a display unit 230 and a first wireless transmission module 240.

In an embodiment of the invention, a plurality of patterns is generated on the touch panel 210 by a manufacturing process. In an embodiment of the invention, the plurality of patterns is composed of conductive materials, such as Indium Tin Oxide (ITO) or metals, and designed by an encoding method, wherein each of the patterns may be composed of different types of geometric forms, such as a triangle form, square form, circular form or other geometric forms, or be composed of the same geometric form but each of the geometric forms is generated by a different design. For example: if all patterns are designed in a triangle form, each triangle may further be processed a different design, e.g. each triangle may be designed by being perforated in different places or generated breaches in different places. Note that the example above is only illustrative, and it is to be understood that the invention is not limited thereto. Those who are skilled in this technology can still use different design method to generate the patterns. In an embodiment of the invention, each of the patterns comprises different encoding information, therefore the information of each of the patterns can be obtained after each of the patterns is decoded. In an embodiment of the invention, the patterns are formed by the uniform distribution.

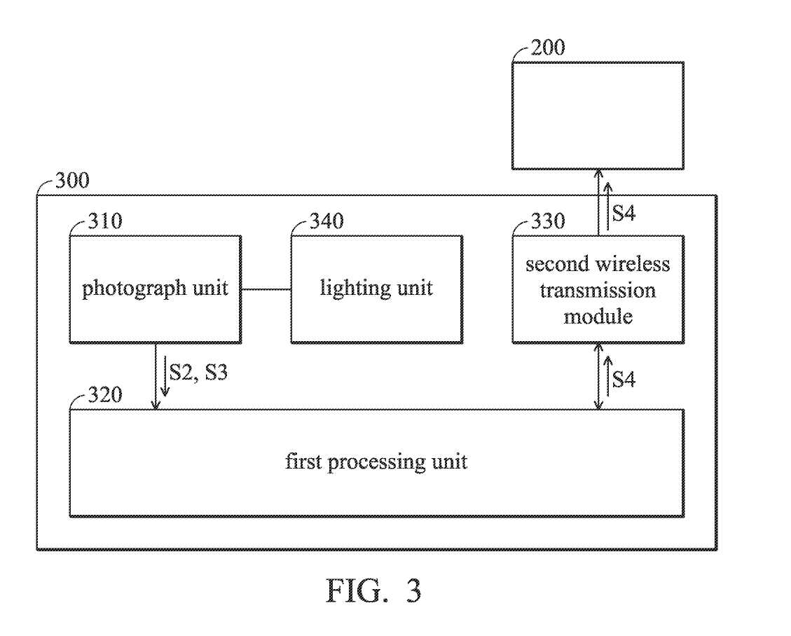

FIG. 3 is a block diagram of the input device 300 according to an embodiment of the invention. In an embodiment of the invention, the input device 300 comprises a photograph unit 310, a first processing unit 320 (the “first” processing unit illustrated in the specification is to be consistent with the disclosure of claims), and a second wireless transmission module 330. In an embodiment of the invention, the photograph unit 310 may be a photograph device with Charge-coupled Device (CCD) or Complementary Metal-Oxide-Semiconductor (CMOS). In an embodiment of the invention, the first processing unit 320 may be a Digital Signal Processor (DSP) or a Microprocessor Control Unit (MCU). The image data may be converted to digital data by the first processing unit 320.

In an embodiment of the invention, when the user inputs message data S1 to the electrical device 200 by the input device 300, the input device 300 may generate image data S2 by photographing the one or more of the patterns by the photograph unit 310, and then analyze location information S3 of the image data S2 by the first processing unit 320 for generating coordinate information S4, and transmit the coordinate information S4 to the electrical device 200 through a wireless transmission method by the second wireless transmission module 330. In an embodiment of the invention, the wireless transmission method may be Bluetooth, 802.11(Wi-Fi), ZigBee, Ultra Wideband, Near Field Communication (NFC) or other wireless transmission method. In an embodiment of the invention, when the image data S2 photographed by the photograph unit 310 is one of the patterns, the first processing unit 320 may analyze the location information S3 comprised in the image data S2 for generating the coordinate information S4 corresponding to this pattern, and then the second wireless transmission module 330 may transmit the coordinate information S4 to the electrical device 200 through a wireless transmission method. In another embodiment of the invention, when the image data S2 photographed by the photograph unit 310 is a combination of more of the patterns, for example, the image data S2 photographed by the photograph unit 310 may be composed of two or three different patterns, the first processing unit 320 may analyze the location information S3 comprised in the image data S2 for generating the coordinate information S4 corresponding to these patterns, and then the second wireless transmission module 330 may transmit the coordinate information S4 to the electrical device 200 through a wireless transmission method. In an embodiment of the invention, the location information S3 may comprise the coordinate corresponding to the patterns, the number of the patterns, the inclination angles or rotation angles of the patterns which are generated according to the inclination angle of the input device 300 on the touch panel 210 or the altitude between the input device 300 and the touch panel 210, the pattern area of the patterns, the geometric form information of the patterns, and so on. The coordinate information S4 corresponding to the message data S1 which the user inputs to the electrical device 200 via the input device 300 may be obtained by analyzing the parameters of location information S3 by the first processing unit 320. In an embodiment of the invention, if the photograph unit 310 only photographed an incomplete pattern, the photograph unit 310 may determine whether the image data S2 needs to be rephotographed according to a preset mechanism. For example, only when the image data S2 displays more than 50% of the pattern area of the pattern may the first processing unit 320 analyze the image data S2, otherwise the photograph unit 310 needs to photograph the image data S2 again. Note that the pattern area of image data S2 not only means the pattern area of a pattern, it also may mean the total area of the combination of more incomplete patterns. When the total area is more than 50% of a complete pattern, the first processing unit 320 may also analyze the image data S2. In addition, the photograph unit 310 may determine whether the image data S2 needs to be rephotographed according to the number of incomplete patterns in the image data S2. For example, only when the image data S2 comprises more than three incomplete patterns may the first processing unit 320 analyze the image data S2. In an embodiment of the invention, if the photograph unit 310 only photographed an incomplete pattern, the first processing unit 320 may analyze the partial location information S3 of the incomplete pattern and try to decode the partial location information S3 for generating the coordinate information S4. If the first processing unit 320 can't decode the partial location information S3 successfully, the first processing unit 320 may instruct the photograph unit 310 to photograph the image data S2 again.

In an embodiment of the invention, the input device 300 further comprises a storage unit (not present in the figure) which is configured to store the location information S3 of all patterns. In an embodiment of the invention, the first processing unit 320 further comprises a decoder (not present in the figure) which is configured to convert the location information S3 to coordinate information S4.

In an embodiment of the invention, when the electrical device 200 receives the coordinate information S4 by the first wireless transmission module 240, the second processing unit 220 may decode the coordinate information S4 to the message data S1 which is user-input, and then the display unit 230 may display the message data S1. In an embodiment of the invention, the input device 300 also only transmits the location information S3 to the electrical device 200. The second processing unit 220 may decode the location information S3 to obtain the coordinate information S4 first, and then decode the coordinate information S4 to obtain the message data S1. Then the display unit 230 may display the message data S1.

In an embodiment of the invention, the input device 300 further comprises a lighting unit 340 which is configured to light the patterns for assisting the photograph unit 310. The lighting unit 340 allows the photograph unit 310 to photograph the patterns more clearly. In an embodiment of the invention, the lighting unit 340 may be an infrared ray device. In an embodiment of the invention, the input device 300 further comprises a reflecting device (not present in the figure) and a lens unit (not present in the figure).

In an embodiment of the invention, the input device 300 further may be applied in other electrical devices. That is to say, more of the same or different types of the electrical devices (such as touch televisions, Tablet PCs, smartphones, and so on) can be operated by the common input device 300. For example, the patterns of the panel of the touch television are designed in a pentagon form, the patterns of the panel of the notebook are designed in a circular form, and the patterns of panel of the smart phone are designed to square form. The patterns also may comprise device information (such as the serial number of the device, manufacturer, user ID, and so on) to identify different electrical devices. The image data S2 photographed by the photograph unit 310 of the input device 300 may be pre-analyzed by the first processing unit 320 for determining the electrical device which the user is operating is the touch television, notebook or smart phone, identifying the owner of the electrical device or obtaining detailed information about the electrical device. Therefore, in the embodiment, the user only uses the input device 300 to operate different electrical device. In this embodiment of the invention, the input device 300 further comprises a storage unit (not present in the figure) which is configured to store the location information S3 of all patterns corresponding to different electrical devices.

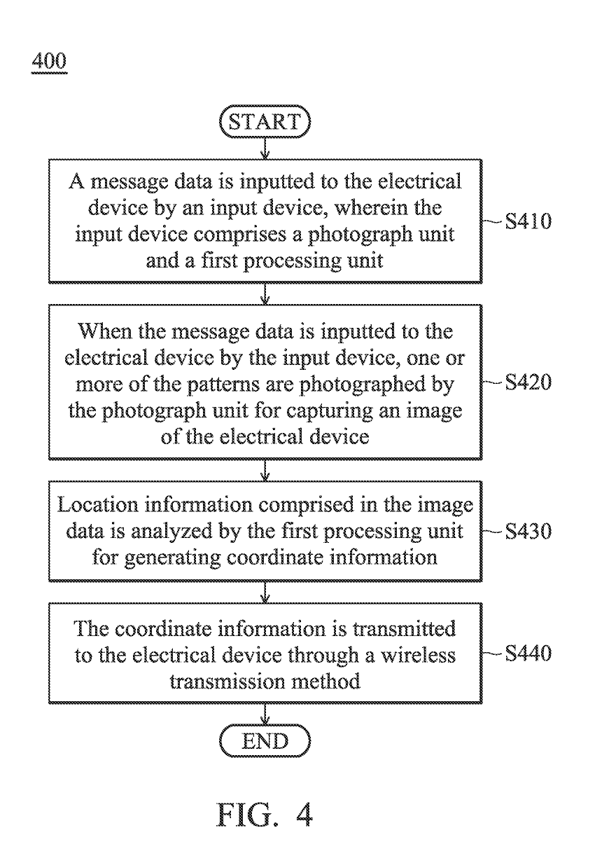

FIG. 4 is a flow chart illustrating the method for analyzing input on touch panel according to an embodiment of the invention. The method is applied to an electrical device with a touch panel, wherein a plurality of patterns are generated on the touch panel by a manufacturing process and the electrical device may be a personal digital assistant (PDA), a smart phone, a note book, a Tablet PC, a Global Positioning System (GPS) or others. Firstly, in step S410, a message data is inputted to the electrical device by an input device, wherein the input device comprises a photograph unit and a first processing unit. In step S420, when the message data is inputted to the electrical device by the input device, one or more of the patterns are photographed by the photograph unit for capturing an image of the electrical device. In step S430, location information comprised in the image data is analyzed by the first processing unit for generating coordinate information. In step S440, the coordinate information is transmitted to the electrical device through a wireless transmission method.

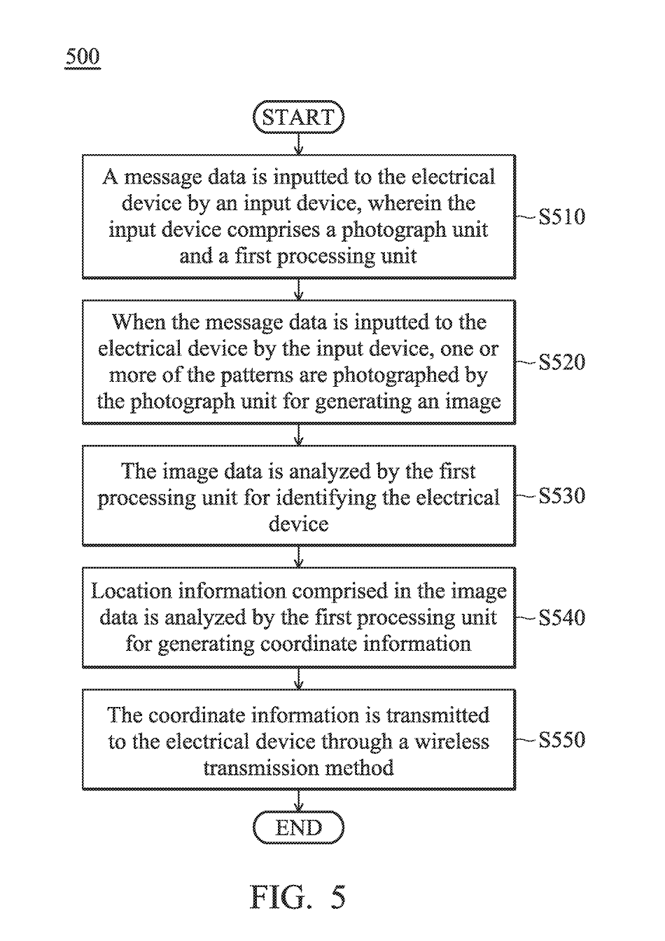

FIG. 5 is a flow chart illustrating the method for analyzing input on touch panel according to another embodiment of the invention. The method is applied to an electrical device with a touch panel, wherein a plurality of patterns are generated on the touch panel by a manufacturing process and the electrical device may be a personal digital assistant (PDA), a smart phone, a note book, a Tablet PC, a Global Positioning System (GPS) or others. Firstly, in step S510, a message data is inputted to the electrical device by an input device, wherein the input device comprises a photograph unit and a first processing unit. In step S520, when the message data is inputted to the electrical device by the input device, one or more of the patterns are photographed by the photograph unit for generating an image. In step S530, the image data is analyzed by the first processing unit for identifying the electrical device. In step S540, location information comprised in the image data is analyzed by the first processing unit for generating coordinate information. In step S550, the coordinate information is transmitted to the electrical device through a wireless transmission method.

Traditionally, the visible Indium Tin Oxide (ITO) or metals on the electrical device are viewed as the issue of manufacturing process. However, in the method for analyzing input on touch panel of the invention, the visible Indium Tin Oxide (ITO) or metals may have a useful application by combining the input device technology. In addition, in the method for analyzing input on the touch panel of the invention, the coordinate information corresponding to the data inputted by the user on the touch panel may be detected by the input device directly and transmitted to the electrical device through the wireless transmission method. The coordinate information corresponding to the data inputted by the user on the touch panel doesn't need to be detected by the electrical device. Therefore, the touch panel of the electrical device doesn't need to arrange an additional printed circuit board assembly (PCBA) for lowering the cost of the manufacturing process. In additional, the method of the invention can apply to different electrical devices. Therefore, the user operates different electrical devices with only one input device. That is to say, the user doesn't need to operate different electrical devices using different input devices respectively corresponding to the electrical devices. Therefore, the method makes operation of multiple devices more convenient.

Memory management methods for mobile devices, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application specific logic circuits.

Reference throughout this specification to “one embodiment” or “an embodiment” means that a particular feature, structure, or characteristic described in connection with the embodiment is included in at least one embodiment of the invention, but do not denote that they are present in every embodiment. Thus, the appearances of the phrases “in one embodiment” or “in an embodiment” in various places throughout this specification are not necessarily referring to the same embodiment of the invention. Furthermore, the particular features, structures, or characteristics may be combined in any suitable manner in one or more embodiments.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents. In addition, reference numbers may be repeated throughout the embodiments, but they do not require that feature(s) of one embodiment apply to another embodiment, even if they share the same reference number.

What is claimed is:

1. A system of analyzing input touch panel, comprising:
an electrical device, comprising a touch panel, wherein a plurality of patterns are generated on the touch panel; and
an input device, comprising a photograph unit and a first processing unit and configured to input a message to the electrical device,
wherein when the message is inputted to the electrical device, the input device photographs one or more of the patterns by the photograph unit for generating an image data, analyzes a location information comprised in the image data by the first processing unit for generating a coordinate information, and transmits the coordinate information to the electrical device through a wireless transmission.

2. The system of claim 1, the electrical device further comprising:
a second processing unit, decoding the coordinate information to the message according to the coordinate information;
a display unit, displaying the message; and
a first wireless transmission module, configured to process the wireless transmission with the input device.

3. The system of claim 1, the input device further comprising:
a second processing unit, configured to process the wireless transmission with the electrical device; and
a lighting unit, configured to light the patterns for assisting the photograph unit.

4. The system of claim 1, wherein the patterns are composed of conductive materials, and designed by an encoding method, and wherein each of the patterns is different.

5. The system of claim 1, wherein the patterns of the electrical device are different from the patterns of another electrical device.

6. The system of claim 1, wherein the patterns comprise device information.

7. A method of analyzing input touch panel for an electrical device which comprises a touch panel, wherein a plurality of patterns are generated on the touch panel, comprising:
inputting a message to the electrical device by an input device, wherein the input device comprises a photograph unit and a first processing unit;
photographing one or more of the patterns by the photograph unit for generating an image data when the message is inputted to the electrical device;
analyzing a location information comprised in the image data by the first processing unit for generating a coordinate information, and
transmitting the coordinate information to the electrical device through a wireless transmission.

8. The method of claim 7, further comprising:
decoding the coordinate information to the message by a second processing unit of the electrical device according to the coordination information;
displaying the message by a display unit of the electrical device; and
processing the wireless transmission with the input device by a first wireless transmission module of the electrical device.

9. The method of claim 7, further comprising:
processing the wireless transmission with the electrical device by a second processing unit of the input device; and
lighting the patterns for assisting the photograph unit by a lighting unit of the input device.

10. The method of claim 7, wherein the patterns are composed of conductive materials, and designed by an encoding method, and wherein each of the patterns is different.

11. The method of claim 7, wherein the patterns of the electrical device are different from patterns of another electrical device and wherein the input device detects types of the electrical devices or obtains the device information according to the patterns photographed by the input device.

12. The method of claim 7, further comprising:
determining whether a pattern area of one of the patterns comprised in the image data is more than a preset ratio; and
analyzing the image data when the pattern area of one of the patterns comprised in the image data is more than the pre-set ratio.

13. The method of claim 7, further comprising:
determining whether the number of incomplete patterns comprised in the image data is more than a pre-set value.
analyzing the image data when the number of incomplete patterns comprised in the image data is more than the pre-set value.
